(19) United States
(12) Patent Application Publication
(10) Pub. No.: US 2015/0021496 A1
(43) Pub. Date: Jan. 22, 2015

(54) METHOD TO ASSIST GEL ANALYSIS AND PROCESSING AND APPARATUS FOR THE SAME

(71) Applicant: Muhammad Imran Shabbir, Gujrat (PK)

(72) Inventor: Muhammad Imran Shabbir, Gujrat (PK)

(21) Appl. No.: 13/944,043

(22) Filed: Jul. 17, 2013

(51) Int. Cl. G01N 27/447; G01B 5/25; G01N 21/64

(52) U.S. Cl. CPC G01N 27/44721; G01N 27/44726; G01N 21/64; G01B 5/25; G01N 2021/6495; G01N 2021/6497
USPC 250/459.1; 33/563

(57) ABSTRACT

A method to assist gel analysis and processing and apparatus for the same is disclosed. The method employs a tracing/marking/measuring/analyzing and referencing template of transparent sheet material comprising of a pattern made of vertical and horizontal lines that form quadrilateral shapes upon intersection. The vertical and horizontal lines are clearly visible in white light and ultraviolet light. The template sheet(s) can be inserted in a square shaped template holding assembly (70) which is used in between a UV trans-illuminator (56) and a macromolecule resolving gel matrix (54) such as agarose or polyacrylamide gels. The template pattern can be made on one sheet of transparent material or separate sheets may contain vertical and horizontal lines and the finalized pattern can be achieved by inserting all the separate sheets in the template holding assembly. Under the UV light from UV trans-illuminator by adjusting the sheets containing vertical lines (13) according to the gel matrix's lanes (32d, 32e, 32f) and horizontal lines (17) according to the area of interest for further analysis and processing, the adjusted pattern of lines (13) and (17) can be used as a reference even in the absence of UV light.

### CROSS-REFERENCE TO RELATED APPLICATIONS

This is a non-provisional application claiming benefit of provisional application 61/741,288 filed on Jul. 18, 2012 entitled A METHOD TO ASSIST GEL ANALYSIS AND PROCESSING AND APPARATUS FOR THE SAME.

### BACKGROUND OF THE INVENTION

1. Field of the Invention

The present invention relates to a method and a device to assist the analysis and processing or gel slice cutting of a biomolecule resolving gel after gel electrophoresis and more specifically to a template device and a method for assisting the tracing, marking, measuring, analyzing, referencing and cutting of slices of the electrophoretic gels.

2. Description of the Prior Art

Gel electrophoresis is one of the most important techniques in life science methods. It is used extensively in the field of biotechnology to separate target biological macromolecules (biomolecules), such as DNA, RNA, or protein form a mixture of biomolecules. This analytical tool is equally important for research purpose as well as quality assurance testing of biomolecules in industry. This procedure, which is done for identification and quantification of biomolecules, separates them into bands, which are then typically stained with a fluorescent dye with an appropriate Stokes shift (that is the discrimination between excitation and emission wavelengths) so that when the gel is irradiated with light at an excitation wavelength the dye emits light at a different wavelength, and the resulting emissions are detected and quantified. Irradiation is commonly achieved by transillumination, i.e., irradiation of the gel at the side opposite the side where detection is performed. A commonly used dye for DNA fragments is ethidium bromide, which is most efficiently excited at wavelengths in the ultraviolet range.

After performing gel electrophoresis, further stages of performance can be divided into “analysis” and “processing” or “gel slice cutting”. For the purpose of definition, “analysis” hereby means viewing of biomolecules in a stained gel on transilluminator for all observable characteristics, for example, band integrity, quality of band separation, expected concentration of biomolecules by comparison with known standard concentration markers, and size of biomolecules by comparison with known standard size markers, analyzing a particular part of gel for size selection or purification of biomolecules and taking the picture of the gel etcetera, on the basis of which decision can be made for “processing” or “gel slice cutting”. For the purpose of definition, “processing” or “gel slice cutting” hereby means removing the desirable part of the gel after analysis with the help of suitable methods available in the art. The removed gel slice can be further used for isolation of biomolecules from the gel slice for purification (gel elution or gel extraction), performing gel electrophoresis again etcetera or any other procedure depending upon the experimental requirement.

Usually biomolecules are observed or analyzed within the stained gel with the help of ultraviolet (UV) irradiation. Conventional method/arrangement of gel analysis includes use of gel on top of UV tans-illuminator with or without gel documentation apparatus. Gel documentation apparatus (GDA) covers the UV emitting area from all sides thus confining the UV radiations within a chamber of the apparatus and this in turn saves a user from UV exposure, however, analysis without GDA is prone to exposure of potentially dangerous UV radiations even with the protective goggles or face shields, especially skin surfaces including throat, hands and arms are at risk. Further, UV radiations also reflect off nearby surfaces thus reaching the user.

After analysis, it is often desirable to remove target biomolecules from a gel polymer (processing or gel slice cutting). Gel slice cutting is generally used for size selection as well as purification of biomolecules. This gel slice cutting is performed directly on the UV trans-illuminator which usually takes more time than analysis. Further, for procedures involving a large number of gel slice cuttings takes longer time from tens of minutes to an hour or even more to cut gel slices. During this time, the user is exposed to harmful UV radiations. Furthermore, prolonged UV exposure may induce photo induced reaction in macromolecule inside the gel matrix that may affect experimental outcome. The use of UV light is therefore of concern not only in the detection of biomolecules but also for a laboratory worker exposed to harmful excitation light.

U.S. Pat. No. 5,327,195 issued to Timothy G. J. Ehr and U.S. Pat. No. 7,030,392 issued to Alex Waluszko describes the basic working principal of transilluminator. Various eye protective means including goggles with ultraviolet rays blocking properties can be employed with these transilluminators as described in U.S. Pat. No. 4,758,079 issued to Wanda Bledose and U.S. Pat. No. 5,016,292 issued to Mark Rademacher.

Smoot et al., in issued U.S. Pat. No. 4,657,655 teaches foto/phoresis apparatus for electrophoretically separating, visualizing and photographing DNA in agarose gels and Ramm et al., in issued patent number WO 98/07022 described a digital imaging system for assays in well plates, gels and blots, both describing the basic principal and working of gel documentation system. Gel documentation systems often come with gel slice cutting means with varying degree of UV protection during the gel cutting process. Slider imager instrument from Maestrogen Inc. of Las Vegas, Nev., USA and other similar instruments provide some degree of protection from UV radiation. However, GelDoc-It® Imaging System from UVP, LLC of Upland, Calif., USA and gel observation and gel cut-out hood named Gel LaBox from MeCan Imaging Inc. of Fujimino-City, Saitama, Japan provides a significant amount of protection from UV radiations, however, these instruments still use UV rays during all the analysis and processing time. Further, the arm and hands of the technician remain restricted to a certain angle during gel slice cutting that may lead to difficult handling of the process. For gel cutting, various means are available in the art besides the traditional method using surgical blade, including U.S. Pat. No. 3,949,471 issued to Leo P. Cawley, U.S. Pat. No. 6,565,728 issued to Brnako Kozulic, U.S. Pat. No. 7,413,908 issued to Caldwell et al.

The present invention comprises a method and an apparatus to assist in gel analysis and processing where UV irradiation is only required for analysis, however processing or gel slice cutting can be performed without the use of harmful UV radiations. As will be better understood from the discussion that follows, the present invention overcomes many of the drawbacks of the prior art devices.

### SUMMARY OF THE INVENTION

In accordance with the present invention, a method and apparatus to assist gel analysis and processing following the electrophoretic separation is described. In a preferred embodiment, the apparatus of the present invention consists of template sheet(s) and a template sheet holding assembly. The template sheet(s) are of transparent material and consist of horizontal and vertical lines that are visible in both visible as well as UV light. These template sheet(s) are used inside the template sheet holding assembly. The template sheet holding assembly along with template sheet(s) is placed on the UV transilluminator and the gel is placed on top of the template sheet holding assembly. Each individual template sheet can be moved inward and outward in its respective slot in the template sheet holding assembly to adjust them according to the gel.

In accordance with the method described in the present invention, the gel is adjusted according to the pattern of the first template sheet containing plurality of pair of vertical lines, each pair being representative of the respective lane of the gel. At this time looking through the gel will give a view such that each lane of the gel has been vertically underlined or represented with vertical lines on both sides. Now, at this point of time UV irradiation can be turned on to view the actual positions of the bands in each lane of the gel. The lane representing vertical lines will also glow in UV light along with the bands. By performing a quick analysis, the band of choice can be selected for processing or gel slice cutting. Once decision is made for the band of choice, it can also be underlined by adjusting the second template sheet containing a single horizontal line to the upper boundary of the selected band of choice. The lower boundary of the band of choice can be underlined by adjusting the third template sheet also containing a single line to the lower boundary of the selected band of choice. This procedure will take few seconds to less than a minute after which UV irradiation can be turned off. By turning UV irradiation off, the bands in the gel will disappear; however, the adjusted pattern of horizontal and vertical lines will be still visible. The quadrilateral shapes formed by the intersection of horizontal and vertical lines in the lanes represent the bands of choice that can be cut accurately with the help of blade or any other suitable and convenient method available in the art.

In another embodiment of the present invention, the pattern of plurality of pair of vertical lines (that will represent lanes) and first horizontal line (that will represent upper boundary of band of interest) can be made on one template sheet, where as the second horizontal line (that will represent lower boundary of band of interest) can be made on second template sheet.

In still another embodiment of the present invention, the pattern and number of horizontal and vertical lines can be made on one or more than one template sheets according to the requirement of analysis, e.g., analysis and comparison of ladders etc. A scale can also be made on a certain template sheet where band migration distances with reference to time needs to be calculated.

Accordingly, it is a primary objective of the present invention to provide a reliable template device and a method for assisting gel analysis and processing or gel slice cutting.

Still another primary objective of the present invention is to provide a device and a method for gel processing or gel slice cutting with minimal to no use of harmful UV radiations where UV irradiation is only used for gel analysis whereas gel processing or gel slice cutting can be performed without the use of harmful UV radiations.

Still one another primary objective of the present invention is to provide a device and method which is easy to hands and arms during gel slice cutting while also protect from harmful radiation.

Still, another objective of the present invention is to provide referencing vertical lines to mark each lane of the gel during gel analysis and processing.

Still, an additional objective of the present invention is to provide referencing horizontal lines at right angle to the vertical lines for comparison of bands that are in line with each other during gel analysis and processing.

Yet another objective of the present invention is to provide referencing horizontal lines at right angle to the vertical lines for comparison of ladders bands that are in line with each other on both ends of the gel to identify the equal or unequal migration rates on both ends of the gel.

Yet an additional objective of the present invention is to provide a device and a method to select or mark the area of the gel for processing or gel slice cutting for further processing.

Various other objectives, advantages, and features of the invention will become apparent to those skilled in the art from the following discussion, taken in conjunction with the accompanying drawing in which:

### BRIEF DESCRIPTION OF THE DRAWINGS

FIG. 1 illustrates the basic principle of the method of the present invention.

FIG. 2 is a perspective view of the conventional method (prior art) of gel analysis and processing.

FIG. 3 is a perspective view of the apparatus to accomplish the principle of the present invention.

FIG. 4 is a perspective view of the method and apparatus of the present invention in practical setup to analyze and process the gel matrix in accordance with the present invention.

FIG. 5 is a view of use of pattern of vertical lines according to the comb used.

### DETAILED DESCRIPTION OF THE INVENTION

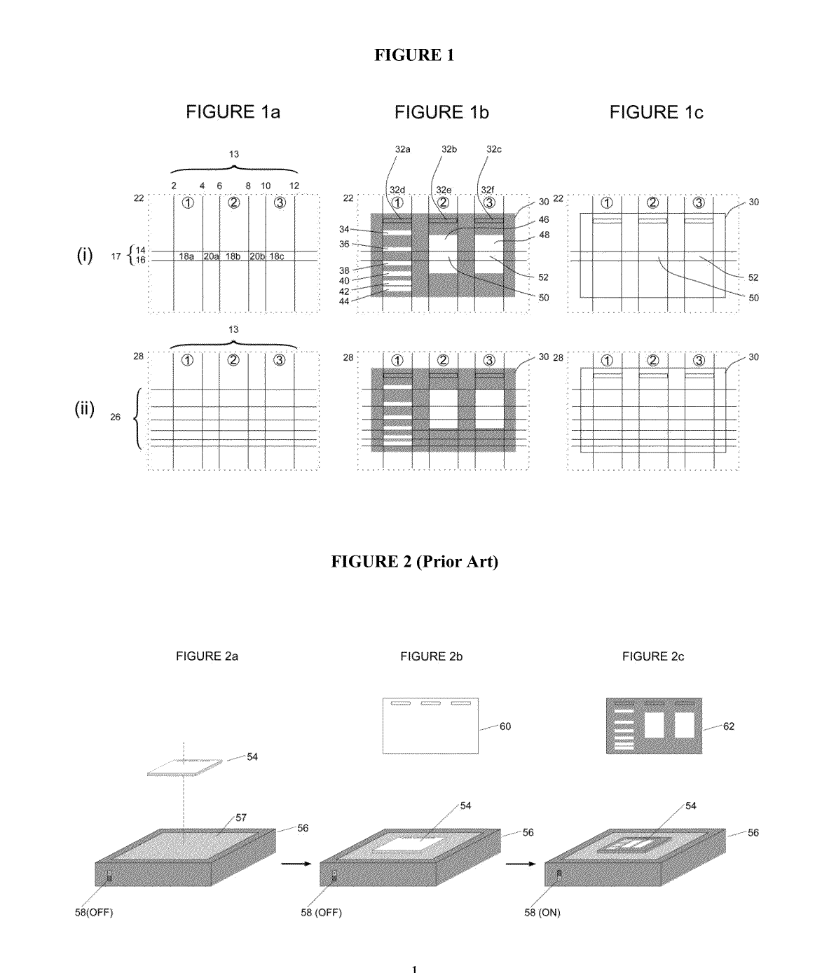

Referring now to the invention in more detail, FIG. 1 describes the basic principle of the method of carrying out the analysis and processing of macromolecule resolving gel matrix (agarose and polyacrylamide gel) in accordance with the present invention.

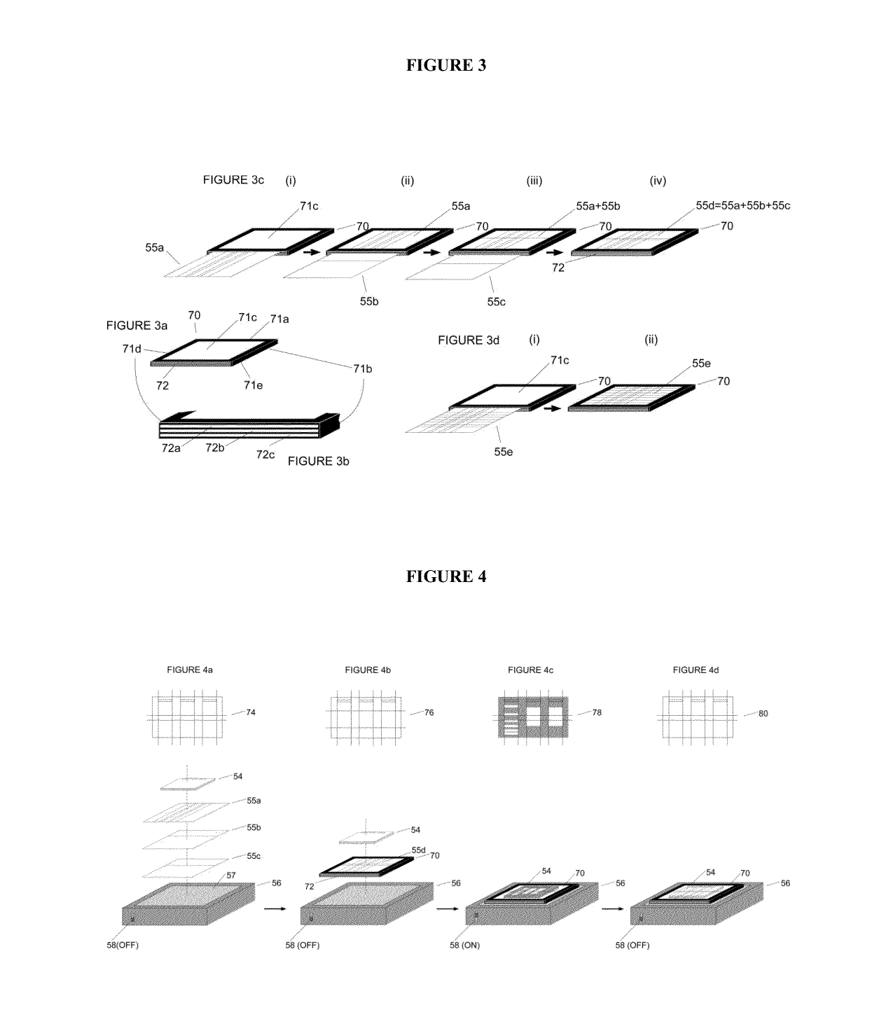

FIG. 1a (i) describe a pattern 22 marked on a substantially square and flexible transparent plastic sheet or other suitable transparent material comprising a set of vertical lines 13 and a set of horizontal lines 17. The set of vertical lines 13 comprised of vertical lines 2, 4, 6, 8, 10 and 12 and the set of horizontal lines 17 comprised of horizontal lines 14 and 16. In the set of vertical lines 13, each pair of vertical lines (2 and 4, 6 and 8, and 10 and 12) represents the respective lane 1, 2 and 3 marked in between the respective vertical lines in circles. The horizontal lines 14 and 16 intersect vertical lines 2, 4, 6, 8, 10 and 12 and form quadrilateral shapes 18a, 20a, 18b, 20b, and 18c. The horizontal and vertical lines can be visually observed in visible and ultraviolet (UV) light spectrum regions. The pattern 22 can be marked on one transparent sheet or different parts of the pattern can be marked on different transparent sheets which when combined gives the same pattern as illustrated in FIG. 3 and FIG. 4.

FIG. 1b (i) describe a gel matrix 30 having rectangular wells 32a, 32b and 32c, where the length of a rectangular well provides the width of the respective lanes 32d, 32e and 32f in which a macromolecule can be resolved. For exemplary purpose, during the electrophoresis, in lane 32d, a size marker is resolved comprising bands 34, 36, 38, 40, 42, and 44, whereas, lane 32e and 32f resolved the wider size range smears 46 and 48 respectively for two different samples.

The pattern 22 when placed under the gel matrix 30 provides tracing/reference lines template for the analysis of the gel matrix. Each pair of vertical lines including 2 and 4, 6 and 8, and 10 and 12 provides boundary line/reference line/tracing line for lanes 32d, 32e, and 32f respectively. Furthermore, horizontal lines 14 and 16 can mark the area of interest in each lane simultaneously.

For example, in order to analyze the smears 46 and 48 in the lanes 32e and 32f in comparison to size marker in lane 32d from size marker band 36 to band 38, the horizontal lines can be arranged so that line 14 defines the lower boundary of band 36 in lane 32d through lanes 32e and 32f and likewise, the horizontal line 16 can be arranged so that it defines the upper boundary of band 38 in lane 32d through lanes 32e and 32f.

The finalized pattern 22 through gel 30 provides reference line around the lanes (vertical lines) and area of interest between band 36 and 38 (horizontal lines). The intersecting quadrilateral shapes 18a, 18b, and 18c represents size range between band 36 and 38, the size range 50 required to be studied in lane 32e, and the size range 52 required to be studied in lane 32f, respectively. Whereas, the quadrilateral shapes 20a and 20b are between the lanes 32d and 32e and lanes 32e and 32f.

FIG. 1c (i) represent the analysis which is preserved even in the absence of UV light and visible through the gel due to the application of principle of the present invention. The quadrilateral shapes 50 and 52 can further be processed to gel cutting for obtaining the required size out of the wide size smears 46 and 48 in the absence of UV light.

FIG. 1a (ii) provides another pattern 28 comprising of a set of vertical lines 13 and a set of horizontal lines 26 for the analysis against multiple bands of the size marker as described in FIG. 1a (ii) and further processing can be done in the absence of UV light as FIG. 1c (ii) illustrate the preserved analysis pattern visible through the gel for further processing of the gel matrix.

FIG. 2 provides the overview of conventional gel analysis and processing. In FIG. 2a, a gel matrix 54 is placed on the UV transilluminator 56 with ON/OFF switch 58 in OFF position. The appearance of gel to an observer/analysis means for example UV protected naked eye or gel imaging/documentation system is depicted as 60 in FIG. 2b describing that the macromolecule are not visible. FIG. 2c describes that when the switch 58 is turned ON, the appearance of gel to an observer/analysis means are illustrated as 62 indicating the presence of resolved macromolecules as being more brighter on the gel. Once analyzed, any further processing need continuous use of UV light. By turning UV lights OFF through switch 58, the appearance of gel will again be similar to 60 due to the absence of UV light. So, in the absence of UV light, no further analysis or processing of the gel can be accomplished.

FIG. 3 describes a tracing/marking/measuring/analyzing and referencing template apparatus comprised of a suitable template sheet(s), for example 55a, 55b, 55c, or 55e and template holding assembly 70.

The template sheet of the present invention is a sheet of transparent flexible plastic material of substantially square shape comprising a pattern of at least a pair or plurality of pairs of mutually parallel vertical lines and a pattern of at least one or more mutually parallel horizontal lines, wherein the intersection of at least one pair (or plurality of pairs) of vertical lines and at least two horizontal lines make quadrilateral shapes. For exemplary purpose, a template sheet 55a comprises of three pairs of vertical lines, template sheet 55b comprises a single horizontal line and template sheet 55c also comprises a single horizontal line but at different location on the sheet than template sheet 55b. The combination of template sheets 55a, 55b and 55c give rise to a pattern similar to pattern 22 as described in FIG. la (i). Another template sheet 55e comprises a pattern of three pairs of vertical lines and six horizontal lines similar to pattern 28 as described in FIG. 1a (ii). The patterns described here are only for exemplary purposes, however, these are not limited and can be expanded to any possibility of the analysis and processing required for the gel electrophoresis.

The template holding assembly 70 of the present invention as illustrated in FIG. 3a provides the means to accomplish the principle of the present invention described in FIG. 1. The template holding assembly 70 is a substantially square shaped rigid structure comprising a top UV transmittable transparent panel 71c and a bottom UV transmittable transparent panel 71e. Further, a right panel 71b and a left panel 71d that are integrally attached to a back panel 71a and a front panel/entry section 72 and integrally attached to these four said panels are the perimeter edges of said top UV transmittable transparent panel 71c and the bottom UV transmittable transparent panel 71e. The gel matrix to be analyzed can be placed on the top UV transmittable transparent panel 71c. The front panel/entry section 72 of template holding assembly 70 further comprises of shelf slots 72a, 72b and 72c as illustrated in FIG. 3b and each of these shelf slots can hold a template sheet.

FIG. 3c describes the achievement of a particular pattern for gel analysis using three different template sheets to achieve a final combined pattern of the said three template sheets in accordance with the principle of the present invention. In FIG. 3c (i), the template sheet comprising a pattern of vertical lines 55a inserted in the slot 72a of the template holding assembly 70 can be observed from the top UV transmittable transparent panel 71c as pattern 55a inside the template holding assembly 70 as described in FIG. 3c (ii). Another template sheet comprising a single horizontal line pattern 55b inserted in slot 72b of the template holding assembly 70 can be observed in FIG. 3c (iii) as pattern 55a+55b inside the template holding assembly 70. Another template sheet comprising a single horizontal line pattern 55c inserted in entrance 72c of the template holding assembly 70 can be observed in FIG. 3c (iv) as pattern 55d which is 55a+55b+55c inside the template holding assembly 70. The template sheets 55b and 55c can be moved a little inward or outward to change the location of respective horizontal lines in the final pattern 55d according to the required location for analysis.

FIG. 3d describes the achievement of a particular pattern for gel analysis using a single template sheet comprising a pattern of horizontal and vertical lines 55e inserted in slot 72a of the template holding assembly 70 as illustrated in FIG. 3d (i), which can be observed from the top UV transmittable transparent panel 71c as pattern 55e inside the template holding assembly 70 as described in FIG. 3d (ii).

FIG. 4 illustrates the practical setup of the method and apparatus for carrying out the analysis and processing of macromolecule resolving gel matrix (agarose and/or polyacrylamide gel) in accordance with the present invention.

FIG. 4a describes the principle setting of the method of the present invention. The template sheets 55a, 55b and 55c comprising different patterns on them are placed in between a gel matrix 54 and the light emitting area 57 of the UV transilluminator 56 with the switch 58 in OFF position. The observer/analysis means can view the pattern through the gel matrix as 74 in the absence of UV light.

FIG. 4b describes the analysis setting of the present invention with the template holding assembly 70, which can hold patterned transparent template sheets 55a, 55b and 55c inside of it through the shelf slots 72a, 72b and 72c of the front panel/entry section 72, respectively. The template holding assembly 70 can be employed as a fixed part of UV tranilluminator 56 or be used as a removable or separate part like a conventional gel tray. The observer/analysis means can view the pattern through the gel matrix as 76 in the absence of UV light. The template sheets 55b and 55c can be moved a little inward or outward in their respective shelf slots to change the location of respective horizontal lines in the final pattern 55d according to the required location for analysis.

FIG. 4c describes the analysis setting similar as FIG. 4b but with switch 58 of UV transilluminator turned ON to view the resolved macromolecules. The observer/analysis means can view the pattern through the gel matrix as 78 in the presence of UV light. The template sheets 55b and 55c can be moved a little inward or outward in their respective shelf slots to change the location of respective horizontal lines in the final pattern 55d according to the required location for analysis. Once the pattern which is required for the further analysis and processing is achieved, the switch 58 can be turned OFF as described in FIG. 4d leaving the finalized pattern 80 as observed by observer/analysis means. The quadrilateral shapes set forth by intersection of horizontal and vertical lines in 80 can serve as reference template for further processing of gel matrix, for example, gel cutting for size selection even in the absence of UV light.

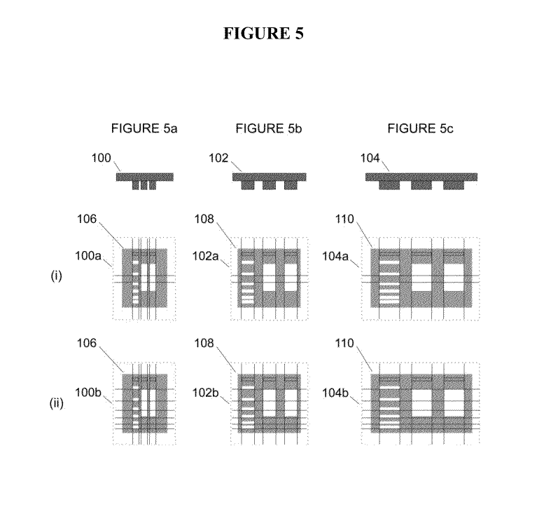

FIG. 5 illustrates the use of pattern of horizontal lines according to the comb used. Different patterns of horizontal lines can be marked according to the combs used for the experiment.

FIG. 5a describes a comb 100 used for making wells in the gel matrix 106 of FIG. 5a (i) and FIG. 5a (ii) with pattern 100a and 100b comprising three pairs of vertical lines representing the respective three lanes according to comb 100.

FIG. 5b describes a comb 102 used for making wells in the gel matrix 108 of FIG. 5b (i) and FIG. 5b (ii) with pattern 102a and 102b comprising three pairs of vertical lines representing the respective three lanes according to comb 102.

FIG. 5c describes a comb 104 used for making wells in the gel matrix 110 of FIG. 5c (i) and FIG. 5c (ii) with pattern 104a and 104b comprising three pairs of vertical lines representing the respective three lanes according to comb 104.

While the invention has been described in complete detail and pictorially shown in the accompanying drawings, it is not to be limited to such details, since many changes and modifications may be made to the invention without departing from the spirit and the scope thereof. Hence it is described to cover any and all modifications and forms which may come within the modifications and forms which may come within the language and scope of claims.

I claim:

1. A tracing/marking/measuring/analyzing and referencing template apparatus comprising:
A. A template sheet of transparent flexible plastic material of substantially square shape comprising:
(a) a pattern of at least a pair or plurality of pairs of mutually parallel vertical lines; and
(b) a pattern of at least one or more mutually parallel horizontal lines;
(c) wherein the intersection of at least one pair (or plurality of pairs) of vertical lines and at least two horizontal lines make quadrilateral shape(s); and
B. A rigid template holding assembly of substantially square shape comprising:
(a) a top UV transmittable transparent panel; and
(b) a bottom UV transmittable transparent panel; and
(c) a right panel and a left panel that are integrally attached to a back panel and a front panel/entry section and integrally attached to these four said panels are the perimeter edges of said top UV transmittable transparent panel and the bottom UV transmittable transparent panel; and
(d) the front panel/entry section having one or more shelf slots for inserting template sheet(s); and

2. The invention of claim 1, wherein the vertical lines are mutually parallel to each other and the horizontal lines are mutually parallel to each other.

3. The invention of claim 1, wherein each pair of vertical lines starting from the first line represents the respective lane of the gel matrix and each said pair of vertical lines may have same, different or any other suitable color scheme and a lane number may also be marked in between the two vertical lines up till next all respective lanes.

4. The invention of claim 1, wherein the vertical and horizontal lines are clearly viewable in ultraviolet and visible light spectrum.

5. The invention of claim 1, wherein the vertical and horizontal lines can be marked on one or more than one transparent sheets or vertical lines can be marked on one transparent sheet and each horizontal line(s) can be marked on other sheet(s).

6. The invention of claim 1, wherein the vertical and horizontal lines can be marked on transparent sheet(s) by printing, drawing or any other suitable means.

7. The invention of claim 1, wherein the template holding assembly is either permanently attached to the UV transilluminator or separate and independent entity which can be applied and removed from UV transilluminator after use and can be stored elsewhere.

8. The invention of claim 1, wherein any pattern of either vertical or horizontal lines can be permanently marked on the template holding assembly and other patterns can be marked on template sheets to be used with template holding assembly.

9. A method to assist gel analysis and processing comprising the steps of:
(a) Placing the template holding assembly on UV transilluminator;
(b) Inserting the first template sheet having pattern of pairs of vertical lines in the first shelf slot of front panel/entry section of the template holding assembly;
(c) Inserting the second template sheet having pattern of first single horizontal line in the second shelf slot of front panel/entry section of the template holding assembly;
(d) Inserting the third template sheet having pattern of second single horizontal lines in the third shelf slot of front panel/entry section of the template holding assembly;
(e) Placing the gel matrix after electrophoresis on the top UV transmittable transparent panel of the template holding assembly in line with the pattern of the first template sheet with pairs of vertical lines such that each pair of vertical lines represent/mark/trace the respective lane of the gel matrix;
(f) Observing the combined pattern of the above said three template sheets in the template holding assembly which will be visible through the gel matrix without UV light;
(g) Turning the UV transilluminator “ON” to emit UV light making the resolved macromolecule in the gel matrix lanes to fluoresce making its location visible in the gel matrix as well as making the combined pattern of vertical and horizontal lines to fluoresce under UV light;
(h) Changing the setting of the second template sheet having pattern of first single horizontal line by moving inward or outward in accordance with setting up the upper boundary of the area of gel matrix required to be analyzed or processed;
(i) Changing the setting of the third template sheet having pattern of second single horizontal line by moving inward or outward in accordance with setting up the lower boundary of the area of gel matrix required to be analyzed or processed;
(j) Observing the quadrilateral shapes formed by intersection of each pair of vertical lines with first single horizontal line and second single horizontal line in the final settings visible through the gel matrix represents the areas of analysis in each lane.
(k) Turning the UV transilluminator “OFF” to stop the emission of UV light.
(l) Processing the said quadrilateral shapes corresponding to each lane, for example gel cutting by any suitable and convenient method known in the art.

10. The method of claim 10, wherein the first template sheet comprising pairs of vertical lines to represent lanes of gel matrix can be designed according to the comb used for making the wells in the gel matrix.
